(19) United States
(12) Patent Application Publication
(10) Pub. No.: US 2020/0150446 A1
(43) Pub. Date: May 14, 2020

(54) Method and System for Improving Lateral Resolution in Optical Scanning Microscopy

(71) Applicant: Université Laval, Québec (CA)

(72) Inventors: Louis THIBON, Québec (CA); Yves DE KONINCK, Québec (CA); Michel PICHÈ, Québec (CA)

(73) Assignee: Université Laval, Québec, QC (CA)

(21) Appl. No.: 15/999,097

(22) PCT Filed: Feb. 15, 2017
(86) PCT No.: PCT/CA2017/050195

§ 371 Date: Aug. 16, 2018

Related U.S. Application Data
(60) Provisional application No. 62/295,819, filed on Feb. 16, 2016.

(51) Int. Cl. G02B 27/09; G02B 5/00; G02B 27/58; G02B 21/00; G02B 21/08; G02B 21/16

(52) U.S. Cl. CPC G02B 27/0988; G02B 5/001; G02B 27/0927; G02B 27/0955; G02B 21/16; G02B 21/0032; G02B 21/0076; G02B 21/08; G02B 27/58

(57) ABSTRACT

A method and system for improving lateral resolution in optical microscopy are provided. The method includes generating a source optical beam and passing the source optical beam successively through an axicon, a Fourier-transform lens and an objective to convert the source optical beam into an excitation Bessel-type beam having a central lobe and at least one side lobe. The method also includes focusing the excitation beam onto a focal plane of the objective within or on a sample to generate a sample light signal, and spatially filtering the sample light signal. The spatial filtering includes rejecting light originating from outside of the focal plane and light generated by the at least one side lobe of the excitation beam. The spatial filtering also includes permitting passage, as a filtered light signal, of light generated by the central lobe of the excitation beam. The method further includes detecting the filtered light signal.

### TECHNICAL FIELD

The general technical field relates to optical microscopy and, in particular, to a method and system for improving lateral resolution in optical microscopy, notably in laser scanning microscopy.

### BACKGROUND

Laser scanning microscopy provides a range of techniques for performing fluorescence imaging of biological samples. By way of example, confocal and multiphoton (e.g., two-photon) microscopes are commonly used for imaging narrow sections of biological structures having features of interest tagged with fluorescent markers. In such applications, a laser beam is focused by an objective lens to a diffraction-limited focal spot inside or on the surface of the specimen. Following illumination by the laser beam, fluorescent light is emitted from the focal spot which, along with scattered and reflected laser light, is collected by the objective lens, separated from the illumination light, and detected by a photodetector. By scanning the sample in three dimensions (3D), a volumetric image of the sample may be obtained pixel by pixel, where the brightness of each pixel is indicative of the relative intensity of detected light emanating from the corresponding focal volume.

Confocal and multiphoton microscopy can provide excellent optical sectioning capabilities, with depths of field of the order of a few micrometers (μm). Using these techniques, multiple in-focus images of thin sections located at different depths inside a thick sample can be acquired sequentially and subsequently combined to provide 3D imaging capabilities. However, although confocal and multi-photon microscopes are usually favored in biological applications due to their z-sectioning capabilities, their lateral resolution at the focal spot remains similar to that of wide-field microscopes.

In microscopy, the maximum achievable lateral resolution is generally limited by the diffraction barrier, also known as the Abbe or Rayleigh limit. In theory, this limit is approximately λ/2, where λ is the wavelength of the illumination light. In practice, however, this limit can generally only be reached with optimized high-numerical aperture instruments. For biomedical or material applications, high resolution is often needed or desirable, and various methods have been developed to improve or overcome this limit.

A first category of methods relies on the optical shaping of the excitation volume and includes stimulated emission depletion (STED) microscopy. STED microscopy is based on the depletion of fluorescence emission in a ring around the focal point using stimulated emission, triplet-state shelving, or reversible saturable optical fluorescence transitions [S. W. Hell et al., “Breaking the diffraction resolution limit by stimulated emission: stimulated emission depletion microscopy”, Opt. Lett. vol. 19, pp. 780-782 (1994); S. W. Hell, “Process and device for optically measuring a point on a sample with high local resolution”, U.S. Pat. No. 5,731,588 (1998); S. Bretschneider et al., “Breaking the diffraction barrier in fluorescence microscopy by optical shelving”, Phys. Rev. Lett. vol. 98, pp. 218103 (2007); M. Hofmann et al., “Breaking the diffraction barrier in fluorescence microscopy at low light intensities by using reversibly photoswitchable proteins”, Proc. Natl. Acad. Sci. USA vol. 102, pp. 17565-17569 (2005)]. STED microscopy can provide a significant increase in resolution, but requires high-peak-power lasers (which can cause photobleaching and possibly photodamage) and/or specific probes (e.g., molecular absorbers/emitters). Also, STED generally cannot be retrofitted into an existing laser scanning microscope and is limited to fluorescence imaging. Complex multi-color confocal and single-color two-photon versions of STED exist, but they are more restrictive in terms of probe selection compared to conventional multi-color confocal and two-photon microscopes [J. Bückers et al., “Simultaneous multi-lifetime multi-color STED imaging for colocalization analyses”, Optics Express vol. 19, pp. 3130-3143 (2011); J. B. Ding et al., “Supraresolution imaging in brain slices using stimulated-emission depletion two-photon laser scanning microscopy”, Neuron vol. 63, pp. 429-437 (2009)].

A second category of methods relies on single-molecule imaging and localization. Such techniques include photo-activation localization microscopy (PALM), stochastic optical reconstruction microscopy (STORM), and other methods based on photo-activation or photo-switching for controlling emitting molecules [H. Shroff et al., “Dual-color super-resolution imaging of genetically expressed probes within individual adhesion complexes”, Proc. Natl. Acad. Sci. USA vol. 104, pp. 20308-20313 (2007); M. Bates et al., “Multicolor super-resolution imaging with photo-switchable fluorescent probes”, Science vol. 317, pp. 1749-1753 (2007); B. Huang et al., “Three-dimensional super-resolution imaging by stochastic optical reconstruction microscopy”, Science vol. 319, pp. 810-813 (2008); X. Zhuang et al., “Sub-diffraction image resolution and other imaging techniques” U.S. Pat. No. 7,776,613]. These methods can determine the position of a molecule with high accuracy, but require specific probes and much longer acquisition times. These methods are also subject to mathematical artifacts since they rely on calculations of the centroid of the diffraction spot.

A third category of methods is referred to as “structured illumination” [P. Kner et al., “Super-resolution video microscopy of live cells by structured illumination”, Nature Methods vol. 6, pp. 339-342 (2009)]. Structured illumination is a wide-field technique that involves excitation of fluorescent species in a sample with a beam made of periodic parallel lines produced by the interference between two laser beams. Multiple images of a sample can be taken at different orientations and phases of the periodic pattern. Data acquisition is followed by sophisticated image processing in order to generate super-resolved images.

A fourth category of methods aims to overcome the resolution limit by using beam-shaping techniques. Non-limiting examples of such techniques include Switching LAser Mode (SLAM) microscopy [H. Dehez et al., “Resolution enhancement in laser scanning microscopy using dark beam imaging”, Optics Express, vol. 21, no. 13, pp. 7128-7142 (2013)] and the use of radially polarized Laguerre-Gauss beams [Y. Kozawa et al., “Lateral resolution enhancement of laser scanning microscopy by a higher-order radially polarized mode beam”, Optics Express, vol. 72, no. 6, pp. 15947-15954 (2011)].

Commercial products based on the STED, STORM and structured illumination techniques have been put on the market. However, the cost of these systems is significantly higher than that of most laser scanning microscopes. Furthermore, these methods inherently rely on fluorescence and on specific photophysical properties of the fluorescent molecular probes.

Various challenges therefore remain in the development of techniques for improving resolution in optical microscopy, in particular laser scanning microscopy, in a practical and cost-effective manner.

### SUMMARY

The present description generally relates to techniques for improving lateral resolution in optical microscopy, in particular laser scanning microscopy.

In accordance with an aspect, there is provided a method for improving lateral resolution in optical microscopy. The method includes:
(a) generating a source optical beam;
(b) converting the source optical beam into an excitation Bessel-type beam having a central lobe and at least one side lobe, the converting including:
   (i) passing the source optical beam through an axicon, thereby converting the source optical beam into an intermediate Bessel-type beam;
   (ii) passing the intermediate Bessel-type beam through a Fourier-transform lens, thereby converting the intermediate Bessel-type beam into an annular beam; and
   (iii) passing the annular beam through an objective, thereby converting the annular beam into the excitation Bessel-type beam;
(c) focusing the excitation Bessel-type beam onto a focal plane of the objective within or on a sample, thereby generating a sample light signal from the sample;
(d) spatially filtering the sample light signal, the spatial filtering including rejecting, from the sample light signal, light originating from outside of the focal plane of the objective and light generated by the at least one side lobe of the excitation Bessel-type beam, and permitting passage, as a filtered light signal, of light generated by the central lobe of the excitation Bessel-type beam; and
(e) detecting the filtered light signal.

In some implementations, step (a) includes generating a laser beam as the source optical beam.

In some implementations, step (a) includes generating a Gaussian beam as the source optical beam, sub-step (i) of step (b) includes generating a Bessel-Gauss beam as the intermediate Bessel-type beam, and sub-step (iii) of step (b) includes generating a Bessel-Gauss beam as the excitation Bessel-type beam.

In some implementations, step (a) includes generating the source optical beam in a wavelength range extending from 200 nanometers to 5 micrometers.

In some implementations, the method further includes a step of adjusting a focal length of the Fourier-transform lens so that a back focal plane of the Fourier-transform lens coincides with a center of the intermediate Bessel-type beam produced by the axicon.

In some implementations, step (d) includes passing the sample light signal through an aperture.

In some implementations, step (d) further includes adjusting at least one of a size, a shape and a position of the aperture in accordance with a width and a position of the central lobe of the excitation Bessel-type beam.

In some implementations, adjusting at least one of the size, the shape and the position of the aperture includes adjusting a linear dimension of the aperture in a range from 1 micrometer to 1 millimeter.

In some implementations, the method further includes a step of scanning the excitation Bessel-type beam over the sample.

In accordance with another aspect, there is provided an optical microscopy system. The optical microscopy system includes:
an optical source configured to generate a source optical beam;
beam-conditioning optics disposed in a path of the source optical beam, the beam-conditioning optics including:
   an axicon positioned and configured to convert the source optical beam into an intermediate Bessel-type beam; and
   a Fourier-transform lens positioned and configured to convert the intermediate Bessel-type beam into an annular beam;
an objective disposed in a path of the annular beam for converting the annular beam into an excitation Bessel-type beam having a central lobe and at least one side lobe, the objective focusing the excitation Bessel-type beam onto a focal plane of the objective within or on a sample, thereby generating a sample light signal from the sample;
a spatial filter disposed in a path of the sample light signal, the spatial filter being configured to reject, from the sample light signal, light originating from outside of the focal plane of the objective and light generated by the at least one side lobe of the excitation Bessel-type beam, and permitting passage, as a filtered light signal, of light generated by the central lobe of the excitation Bessel-type beam; and
a detector configured to detect the filtered light signal.

In some implementations, the optical source is a laser source configured to generate a laser beam as the source optical beam.

In some implementations, the system is configured for one of confocal laser scanning microscopy and two-photon laser scanning microscopy.

In some implementations, the optical source is configured to generate a Gaussian beam as the source optical beam, the axicon is positioned and configured to generate a Bessel-Gauss beam as the intermediate Bessel-type beam, and the objective is positioned and configured to generate a Bessel-Gauss beam as the excitation Bessel-type beam.

In some implementations, the system further includes a switching module disposed between the optical source and the beam-conditioning optics, the switching module being configured for operation between a first operating mode, wherein the switching module directs the source optical beam onto the beam-conditioning optics, and a second operating mode, wherein the switching module directs the source optical beam along a path that bypasses the beam-conditioning optics.

In some implementations, the optical source is configured to generate the source optical beam in a wavelength range extending from 200 nanometers to 5 micrometers.

In some implementations, the axicon is a refractive axicon.

In some implementations, the axicon has an axicon angle ranging from 1° to 5°.

In some implementations, the Fourier-transform lens has an adjustable focal length.

In some implementations, the system further includes a scanning module configured to relay the annular beam generated by the Fourier-transform lens to the objective and to scan the excitation Bessel-type beam over the sample.

In some implementations, the axicon and the Fourier-transform lens are separated from each other by a distance such that a back focal plane of the Fourier-transform lens coincides with a center of the intermediate Bessel-type beam produced by the axicon.

In some implementations, the Fourier-transform lens has a front focal plane and the objective has a back-aperture plane, the front focal plane of the Fourier-transform lens being optically conjugate with the back-aperture plane of the objective.

In some implementations, the spatial filter includes a light-blocking portion surrounding an aperture, the light-blocking portion being configured to reject the light originating from outside of the focal plane and the light generated by the at least one side lobe of the excitation Bessel-type beam, and the aperture being configured to permit passage therethrough of the light generated by the central lobe of the excitation Bessel-type beam.

In some implementations, the aperture has a size ranging from 1 micrometer to 1 millimeter.

In some implementations, the aperture has at least one of an adjustable size, an adjustable shape and an adjustable position.

In some implementations, the aperture is circular.

Other features and advantages of the present description will become more apparent upon reading of the following non-restrictive description of specific embodiments thereof, given by way of example only with reference to the accompanying drawings.

### BRIEF DESCRIPTION OF THE DRAWINGS

FIG. 1 is a schematic representation of an optical microscopy system, in accordance with an embodiment. The optical imaging system in FIG. 1 is configured for laser scanning confocal fluorescence microscopy.

FIG. 2 is a schematic representation of a Bessel beam as a superposition of a continuum of uniform plane waves whose wave vectors form a cone of apex angle β.

FIG. 3 is a schematic representation of the conversion of a Gaussian beam into a Bessel-Gauss beam, the conversion being achieved as a result of passing the Gaussian beam through an axicon.

FIG. 4A is a calculated contour plot of the transverse intensity distribution in the focal plane of an objective of a vertically polarized Gaussian beam. FIG. 4B is a calculated contour plot of the transverse intensity distribution in the focal plane of an objective of a vertically polarized Bessel-Gauss beam. FIG. 4C compares the normalized radial intensity profiles of the Gaussian and Bessel-Gauss beams of FIGS. 4A and 4B, respectively. The calculations in FIGS. 4A to 4C were performed using the vectorial diffraction theory of Richard and Wolf.

FIG. 5 is a schematic representation of beam-conditioning optics for use in an optical microscopy system, in accordance with an embodiment. The beam-conditioning optics, which includes an axicon and a Fourier-transform lens, is optically linked with an objective of the optical microscopy system.

FIGS. 6A to 6C depict the experimental transverse point spread function (PSF) of a confocal microscope under Bessel-Gauss illumination for three different pinhole sizes (FIG. 6A: 25 μm; FIG. 6B: 15 μm; FIG. 6C: 10 μm. The experimental transverse PSFs were measured using 100-nanometer (nm) fluorescent nanospheres at a wavelength of 532 nm. The scale bar is 500 nm. The denomination “AU” in FIGS. 6A to 6C stands for Airy unit.

FIG. 7A presents the intensity distribution in the x-z plane of the PSF obtained with a conventional confocal microscope under Gaussian illumination. FIG. 7B is the longitudinal intensity profile of the main peak of the intensity distribution of FIG. 7A. The measurements were made using 100-nm fluorescent nanospheres at a wavelength of 532 nm.

FIG. 8A presents the intensity distribution in the x-z plane of the PSF obtained with a confocal microscope under Bessel-Gauss illumination, in accordance with an embodiment. FIG. 8B is the longitudinal intensity profile of the main peak of the intensity distribution of FIG. 8A. The measurements were made using 100-nm fluorescent nanospheres at a wavelength of 532 nm.

FIGS. 9A and 9B are schematic representations of an optical microscopy system, in accordance with another embodiment, the optical microscopy system including a switching module configured for operation between a first operating mode (FIG. 9A), where the source optical beam is received by the beam-conditioning optics, and a second operating mode (FIG. 9B), where the source optical beam bypasses the beam-conditioning optics.

FIG. 10 is a flow chart of a method for improving lateral resolution in optical microscopy, in accordance with an embodiment.

FIGS. 11A to 11C are an experimental demonstration of resolution enhancement in confocal imaging obtained using an implementation of the techniques described herein.

FIG. 11A is a confocal image of a sample of 100-nm fluorescent nanospheres observed with a Gaussian beam. FIG. 11B is the same as FIG. 11A, but observed with a Bessel-Gauss beam. FIG. 11C shows normalized profiles along the straight lines in FIGS. 11A and 11B. The horizontal solid line in FIG. 11C corresponds to the resolution measured between the two maxima of the Bessel-Gauss profile. The pinhole diameter is 10 μm. The scale bar is 510 nm. The images were filtered with a Gaussian filter having a full width at half maximum (FWHM) of one pixel.

FIGS. 12A to 12C are an experimental demonstration of resolution enhancement in confocal imaging obtained using an implementation of the techniques described herein. FIG. 12A is a confocal image of microtubules stained by immunohistochemistry (monoclonal anti α-tubulin primary antibody; revealed by a donkey anti-mouse Rhodamine RedX-labeled secondary antibody) observed with a Gaussian beam. FIG. 12B is the same as FIG. 12A, but observed with a Bessel-Gauss beam. FIG. 12C shows normalized integrated profiles (5-pixel width line) along the straight lines in FIGS. 12A and 12B. The horizontal solid line in FIG. 12C corresponds to the resolution measured between the two maxima of the Bessel-Gauss profile. The pinhole diameter is 10 μm. The scale bar is 510 nm. The images were filtered with a Gaussian filter having a FWHM of one pixel.

FIGS. 13A to 13C are an experimental demonstration of resolution enhancement in confocal imaging obtained using an implementation of the techniques described herein. FIG. 13A is a confocal image of gephyrin immunodetected by a monoclonal mAb7a Oyster 550 coupled antibody (excitation maximum at 551 nm) observed with a Gaussian beam. FIG. 13B is the same as FIG. 13A, but observed with a Bessel-Gauss beam. FIG. 13C shows normalized profiles along the straight lines in FIGS. 13A and 13B. The dotted line in FIG. 13C corresponds to the resolution measured between the two maxima of the Bessel-Gauss profile. The pinhole diameter is 10 μm. The scale bar is 1000 nm. The images were filtered with a Gaussian filter having a FWHM of one pixel.

FIGS. 14A and 14B are schematic representations of part of an exemplary embodiment of an optical microscopy system, illustrating how the spatial filter provided in the system is configured to reject, from the sample light signal, the portion of light originating from outside of the focal plane of the objective (FIG. 14A); and the portion of light generated by the at least one side lobe of the excitation Bessel-type beam (FIG. 14B).

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The present description generally relates to techniques for improving lateral resolution in optical microscopy. In particular, the present description relates to an optical microscopy system and a method for obtaining a high-resolution image of a volume of a sample, namely an image having an improved lateral resolution compared to conventional systems and methods.

In some implementations, the techniques described herein use beam conditioning or shaping to improve lateral resolution in laser imaging microscopy, without requiring specific fluorophores or several data acquisitions. More particularly, and as described in greater detail below, the present techniques use Bessel-type beams (e.g., Bessel-Gauss beams) for sample illumination. Bessel-type beams can have a sharp and narrow central lobe, which can produce a small focal spot in the focal plane in or on the specimen under observation. This feature of Bessel-type beams makes them interesting candidates for high-resolution microscopy applications. However, Bessel-type beams also possess an extended depth of field and a series of concentric side lobes surrounding the central lobe. The extended depth of field and the side lobes of Bessel-type beams can generate background and out-of-focus signal light, which, in turn, can degrade resolution, contrast and optical sectioning capabilities; produce artifacts and noise; increase photodamage; or otherwise deleteriously affect image quality.

In order to benefit from the small focal spot of Bessel-type beams to improve lateral resolution, while circumventing or reducing at least some of the undesirable effects of their side lobes and extended depth of field, the present techniques include, inter alia, a step of spatially filtering the sample light signal emanating from the illuminated sample. By applying a spatial filter on the sample light signal, portions of the sample light generated by the central lobe of the excitation Bessel-type beam are detected, while portions of the sample light generated by the side lobes and/or originating from outside of the focal plane are rejected.

In the present description, the term “laser imaging” broadly refers to imaging techniques where laser radiation is used for sample illumination, and where “sample light” emanating from the sample as a result of laser illumination is collected and detected in order to acquire an image of the sample. As known in the art, this sample light can originate not only from scattering, reflection or transmission of the illumination laser beam, but also from fluorescence emission and/or nonlinear optical processes.

Laser imaging systems or microscopes usually involve a scanning of the laser beam over the sample in order to build an image thereof on a pixel-by-pixel basis, each pixel generally representing the observation of one diffracted-limited region of the sample. The present techniques can therefore be applied for each pixel of the image to be constructed, resulting in a full image of the sample when these pixels are combined as is known to one skilled in the art.

Non-limiting examples of microscopic systems that may benefit from the present techniques include, without being limited to: confocal microscopes; multiphoton microscopes (e.g., two-photon microscopes); second-harmonic imaging or third-harmonic imaging microscopes; reflectance microscopes; coherent anti-Stokes Raman scattering systems (CARS); stimulated Raman scattering systems; sum-frequency generation systems; and the like.

It will be understood that any sample that can be studied with conventional laser imaging techniques may a priori benefit from the techniques described herein. In some embodiments, the sample may be a biological specimen. The biological specimen can contain, without being limited to, endogenous fluorescent molecules suitable for laser scanning fluorescence imaging; intrinsic signals detectable through other imaging modalities (e.g., second or third harmonic generations and Raman scattering); and/or exogenous fluorophores or contrast agents, that is, molecules designed to label biological structures and monitor biological functions. Non-limiting examples of biological specimens that can be studied using the present techniques include tissue, cells, and subcellular structures, living or not. Meanwhile, non-limiting examples of biological functions include ion or voltage fluctuations, dynamic reshaping of cellular structures, and cell migration.

In the present description, the term “resolution” refers, unless otherwise stated, to spatial resolution, and is intended to refer to the capability of an imaging system to resolve closely placed objects or to distinguish fine details in a sample under observation. Spatial resolution may be characterized by a PSF, which describes the output of an imaging system to a point source or point object. Spatial resolution can be expressed in terms of length, for example as the FWHM value of the PSF. As known in the art, the image to a point source has a defined size due to diffraction effects and, in practice, also to aberrations in the optics forming the imaging system.

In general, spatial resolution can be characterized as being either axial or lateral. The term “axial resolution”, or equivalently “depth of field” or “depth of focus”, refers to resolution along the optical axis of the illumination beam. Meanwhile, the term “lateral resolution”, or equivalently “transverse resolution”, is used herein to refer to resolution in the focal plane of the illumination beam, which is perpendicular to the optical axis. The lateral resolution defines the size of the focal spot in the focal plane.

The term “high-resolution” generally refers herein to a resolution that exceeds the resolution typically achievable in conventional laser imaging methods and systems. By way of example, the lateral resolution of Gaussian beams commonly used in laser scanning microscopy is roughly equal to half the wavelength, corresponding to a minimum achievable resolution of about 200 nm in the visible portion of the electromagnetic spectrum. In contrast, some embodiments of the techniques described herein employ Bessel-Gauss excitation beams rather than Gaussian beams in order to improve lateral resolution, with no or minimal degradation in terms of axial resolution. More particularly, in some embodiments, it has been found that using Bessel-Gauss beams rather than Gaussian beams can improve the lateral resolution of a confocal microscope by about 20 percent, without significantly compromising the axial resolution.

It is noted that in the present techniques, the configuration for generating Bessel-type beams, which involves an axicon and a Fourier-transform lens, is similar to that described in commonly assigned U.S. Pat. No. 9,201,008, the disclosure of which is incorporated herein by reference in its entirety.

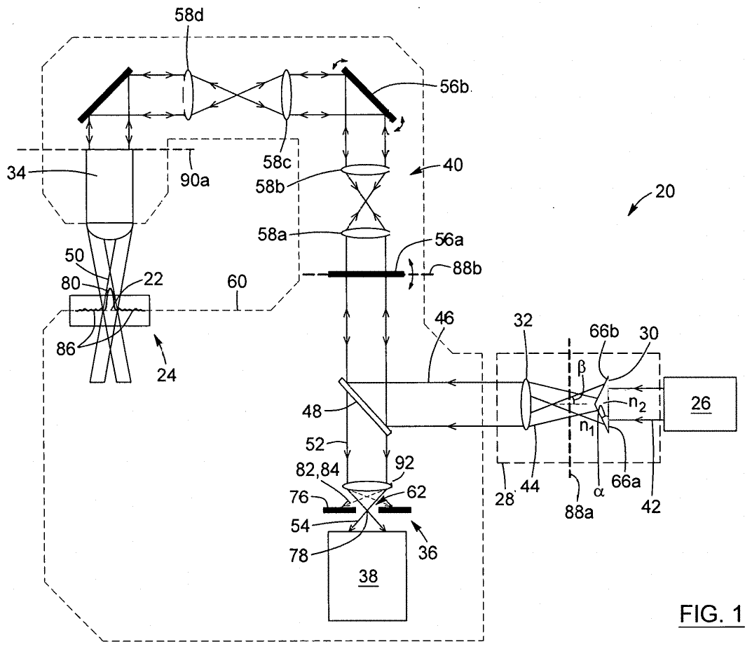

Referring to FIG. 1, there is illustrated an exemplary embodiment of an optical microscopy system 20 for obtaining a high-resolution image of a volume 22 of a sample 24. Depending on the context, the volume 22 of the sample 24 may refer to the whole or a portion of the sample 24.

It is noted that the particular configuration for the optical microscopy system 20 described below with reference to FIG. 1 is provided by way of example only. In practice, the optical microscopy system 20 may be embodied by a number of other components and configurations. Accordingly, while the embodiment of the system 20 shown in FIG. 1 is a confocal laser scanning microscope, other embodiments may be configured for multi-photon (e.g., two-photon) scanning microscopy or any other type of laser scanning microscopes or imaging systems, such as those listed above.

Broadly described, the optical microscopy system 20 generally includes an optical source 26; beam-conditioning optics 28 including an axicon 30 and a Fourier-transform lens 32; an objective 34; a spatial filter 36; and an optical detector 38. The optical microscopy system 20 can also include a scanning module 40. More regarding various structural and operational features of these and other possible components of the optical microscopy system 20 will be described in greater detail below.

The optical source 26 can be embodied by any appropriate device or combination of devices able to generate a source optical beam 42 suitable for illuminating and probing the volume 22 of the sample 24 in the context of the present system 20. In the illustrated embodiment, the optical source 26 is a laser source generating a laser beam as the source optical beam 42. Depending on the intended application, the laser source can include, without being limited to, a gas laser, an electrically-pumped semiconductor laser, an optically-pumped solid-state laser, an optical fiber laser, a solid state amplification system, a mode-locked titanium-sapphire (Ti:sapphire) laser, an optical parametric oscillator, the second-harmonic or third-harmonic generation of any of the preceding sources, and the difference or sum frequency generation of any combination of the preceding sources, and the like. The laser source may be operated in both continuous-wave and pulsed regimes.

In the present description, the term “laser beam” is understood to refer to a high-intensity, spatially-coherent and nearly monochromatic beam of electromagnetic radiation. Depending on the intended application, the radiation forming the laser beam may include photons having energies lying in any appropriate region of electromagnetic spectrum, including the visible, infrared and ultraviolet ranges. In particular, it should be mentioned that the terms “light”, “optical” and variants thereof as used herein are not limited to visible light, but may also include the microwave, infrared and ultraviolet ranges.

The source optical beam 42 may be characterized by several optical characteristics such as, for example, its wavelength, frequency, intensity, polarization, divergence and size. In particular, when the source optical beam 42 is a pulsed laser beam, it may further be described in terms of its pulse duration, repetition rate, spatial and spectral profiles, and the like. It will be understood that the source optical beam 42 may have any optical characteristics suitable for a given application.

By way of example, in the embodiment of FIG. 1, the optical source 26 is configured to generate the optical source beam 42 as a Gaussian laser beam whose transverse electrical field E(r)˜exp[−r²/w²(z)] and intensity distribution I(r)˜exp[−2r²/w²(z)] are well approximated by Gaussian functions, where r is the radial coordinate in a plane transverse to the optical axis of the beam 42 and w(z) is the lateral width of the beam 42. It is noted that the width of the Gaussian beam 42 entering the axicon 30 can modify the depth of field of the excitation beam incident on the sample 24. In particular, it is generally found that the larger the width of the Gaussian beam 42, the longer the depth of field. However, in other implementations, the optical source beam 42 need not be a Gaussian beam. For example, the optical source beam 42 could be a top-hat beam or have another suitable beam profile.

It is worth noting that while the embodiments described herein are directed to a laser imaging system having a laser source for generating a laser beam, other types of optical sources could, in principle, be used in other embodiments if such optical sources are able to generate an optical beam from which a suitable Bessel-type beam can be produced for sample illumination and high-resolution imaging using the techniques described herein. For example, such optical sources can include light-emitting diodes (LEDs) and laser-pumped nonlinear optical sources.

Referring still to FIG. 1, the beam-conditioning optics 28 is disposed in the path of the source optical beam 42, between the optical source 26 and the objective 34. In some implementations, the beam-conditioning optics 28 may be retrofitted into an existing optical microscopy system. Alternatively, in other implementations, the optical microscopy system 20 may be designed and built with the beam-conditioning optics 28 already incorporated therein. Depending on the application, the optical link between the optical source 26 and the beam-conditioning optics 28 can be provided in various ways including, without being limited to, propagation through optical fibers and/or free-space propagation.

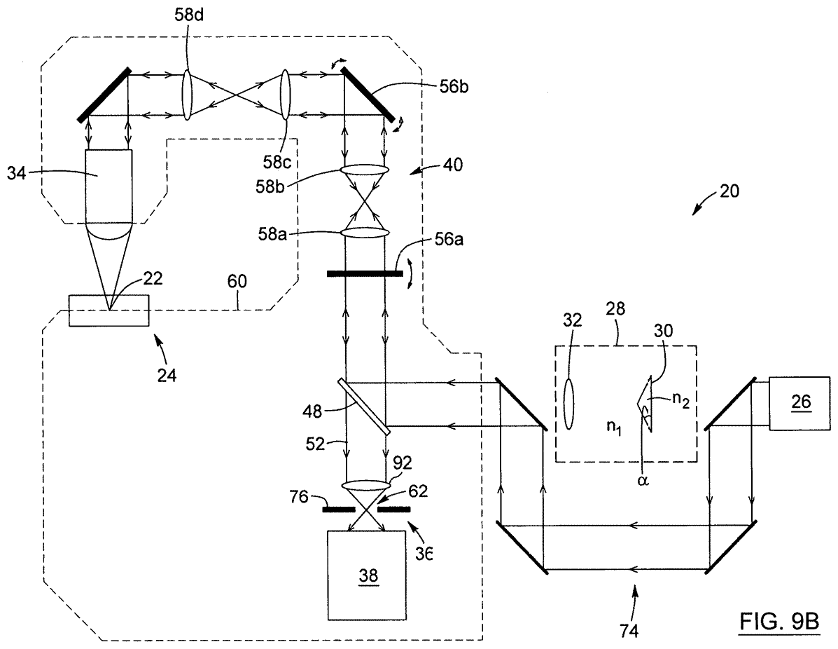

Turning to FIGS. 9A and 9B, in some embodiments, the optical microscopy system 20 may be designed so as to include two distinct light paths. In one of the paths, the optical beam 42 outputted by the optical source 26 passes through the beam-conditioning optics 28, while in the other path, the optical beam 42 generated by the optical source 26 reaches the objective 34 without passing through the beam-conditioning optics 28. In such embodiments, the optical microscopy system 20 can include a switching module 74 disposed between the optical source 26 and the beam-conditioning optics 28. The switching module 74 is configured for operation between a first mode (FIG. 9A) and a second mode (FIG. 9B). In the first mode, the switching module 74 directs the source optical beam 42 onto the beam-conditioning optics, as illustrated in FIG. 9A. Meanwhile, in the second mode, the switching module 74 directs the source optical beam 42 toward the objective 34, along a path that bypasses or avoids the beam-conditioning optics 28. By way of example, the switching module 74 may be embodied by a set of deflecting mirrors, but any other suitable device or combination of devices able to selectively steer the source optical beam 42 along different optical paths can be used in other variants.

As described in greater detail below, the beam-conditioning optics 28 first converts the optical beam 42 generated by the optical source 26 into an intermediate Bessel-type beam 44, and then converts this intermediate Bessel-type beam 44 into an annular beam 46 to be received by the objective 34.

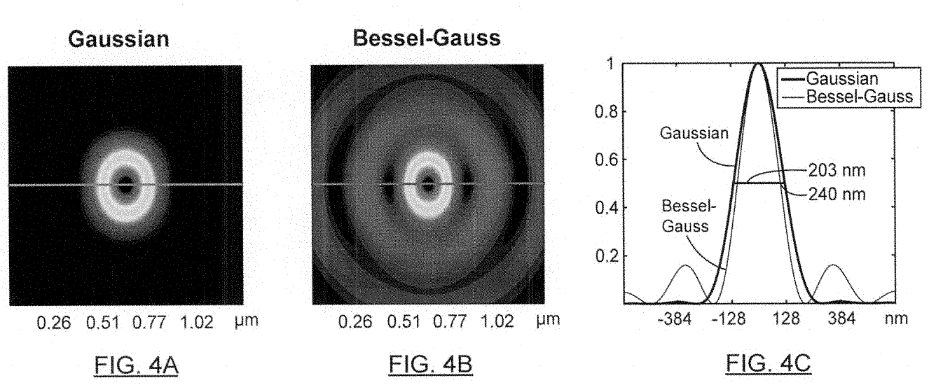

The beam-conditioning optics 28 includes an axicon 30 positioned and configured for converting the source optical beam 42 into an intermediate Bessel-type beam 44. By way of example, in the embodiment of FIG. 1, the intermediate Bessel-type beam 44 produced by the axicon 30 from the Gaussian beam 42 generated by the optical source 26 is a Bessel-Gauss beam (see also FIG. 3).

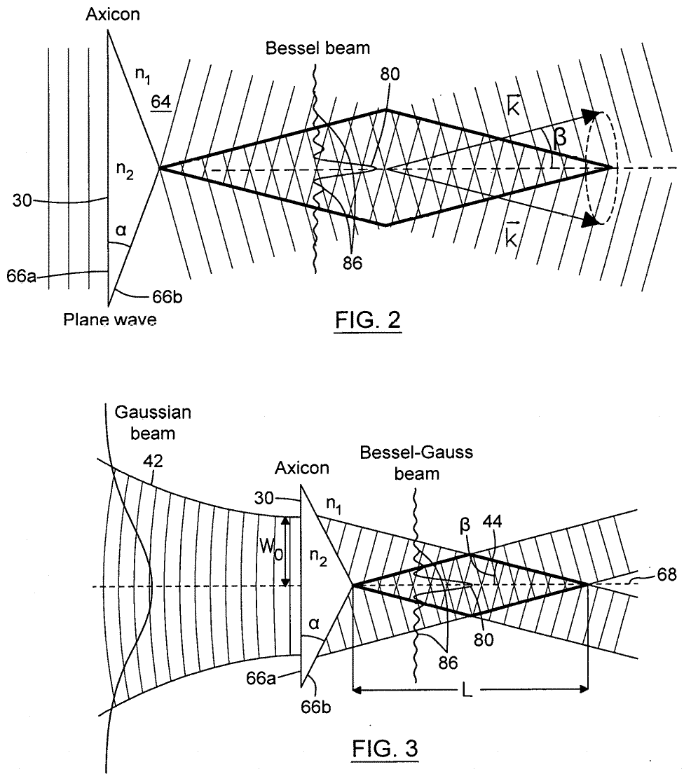

In the present description, the term “axicon” refers broadly to an optical element which has the property that a point source on its optical axis is imaged as a line defining a focal zone or length along its optical axis. In the embodiment of FIG. 1 (see also FIGS. 2 and 3), the axicon 30 is a refractive axicon having a rotationally symmetric surface and embodied by a conical lens formed by the association of a plane surface 66a and a conical surface 66b. The axicon 30 can be characterized by its refractive index n₂ and by the axicon angle α defined between the plane and conical surfaces 66a, 66b. In some non-limiting implementations, the angle α of the axicon 30 may be of the order of a few degrees, for example between 1 and 5 degrees. By way of example, in one exemplary embodiment, the axicon angle α may be equal to about 2.5 degrees. Of course, in other embodiments, other optical components or systems can be used to produce an intermediate Bessel-type beam with the required or desired characteristics including, without limitation, other refractive axicons (e.g., logarithmic axicons and Fresnel axicons), reflective axicons such as conical mirrors, diffractive axicons and phase-profile-produced axicons (generally, but not necessarily, produced by means of a spatial light modulator), holographic elements, diffractive holographic elements, circular gratings, a combination of an annular aperture and a Fourier transform lens, or an optical element with suitably large spherical aberration.

Axicons can be used to transform an incident beam (e.g., a Gaussian beam) into a Bessel-type beam (e.g., a Bessel-Gauss beam), which is an approximation of an ideal Bessel beam. As known in the art, a Bessel beam is a type of non-diffracting beam corresponding to a propagation invariant solution of the Helmholtz wave equation in circular cylindrical coordinates.

In the present description, the term “non-diffracting beam” refers to a beam of electromagnetic radiation whose transverse intensity profile remains substantially constant over a relatively long distance along the optical axis of the beam. The term “transverse intensity profile” as used herein generally refers to the spatial distribution of intensity of electromagnetic radiation as a function of lateral distance from the optical axis of the beam. A non-diffracting beam may thus propagate over long distances without experiencing significant divergence. In addition to Bessel beams, other exact non-diffracting solutions of the Helmholtz wave equation exist such as, for example, Mathieu beams in elliptic coordinates and parabolic beams in parabolic coordinates.

The transverse intensity profile of a Bessel beam is proportional to the square of a Bessel function of the first kind and order zero J₀(x). As known in the art, the function J₀(x) exhibits an intense central lobe 80 surrounded by an infinite set of concentric rings, referred to as side lobes 86 (see, e.g., FIG. 2). The peak intensity of the side lobes decreases as a function of radial distance from the central lobe, though the energy carried by each side lobe is about the same as that carried by the central lobe.

Turning to FIG. 2, a Bessel beam may be represented as a superposition of a continuum of uniform plane waves whose wave vectors k lie on a cone of angle β given by β=sin⁻¹[(n₂/n₁)sin α]−α, where n₁ is the refractive index of the medium 64 surrounding the axicon 30, and n₂ and α are respectively the refractive index of the axicon 30 and the angle between the flat and conical surfaces 66a, 66b of the axicon 30. Because of its non-diffracting nature, the central lobe 80 of an ideal Bessel beam has a constant radius or width, regardless of its distance from the axicon 30. In other words, the transverse intensity profile of an ideal Bessel beam does not change under free space propagation. Bessel beams also have an extended depth of field L along the optical axis.

As known in the art, ideal non-diffracting beams such as Bessel beams are not physically realizable as they would have, in theory, infinite extent and energy. However, methods are known by which close approximations of an ideal Bessel beam can be generated. In this context, the term “Bessel-type beam” can be employed herein to refer to any experimentally realizable representation of an Ideal Bessel beam.

A non-limiting example of a Bessel-type beam is a Bessel-Gauss beam, which can be produced by adding a Gaussian envelope to an ideal Bessel beam. Bessel-Gauss beams retain most of the non-diffractive nature and the extended depth of field of the ideal Bessel beam. Bessel-Gauss beams have been used in various microscopy techniques including, but not limited to, light sheet microscopy, extended-depth-of-field microscopy, CARS microscopy, and STED microscopy.

Referring now to FIG. 3, a schematic ray-trace representation is depicted that illustrates how a Bessel-Gauss beam 44 can be obtained by illuminating an axicon with a Gaussian beam 42. It is seen that a Bessel-Gauss beam 44 corresponds to the superposition of a continuum of Gaussian beams whose wave vectors form a cone of angle β with respect to the propagation axis 68. An advantage of using an axicon 30 to generate a Bessel-Gauss beam 44 is that the axicon 30 preserves most of the power contained in the input Gaussian beam 42, especially compared to other methods for generating Bessel-Gauss beams based on annular apertures. In addition, an axicon 30 can be used to generate Bessel-Gauss beams 44 of different order and having different polarizations, while at the same time being generally easier to align, less sensitive to misalignment and less expensive than phase or amplitude modulators.

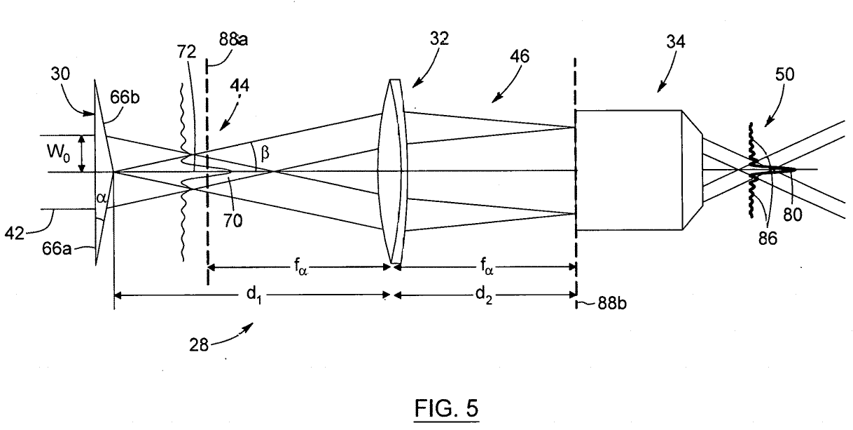

As mentioned above, another characteristic of interest of Bessel-type beams is that they possess a tight focal spot. In particular, the focal spot produced by a Bessel-Gauss beam is typically smaller than that of the corresponding Gaussian beam that can be produced using the same objective. This means that Bessel-Gauss beams can, in principle, provide a better lateral resolution than Gaussian beams. This feature is illustrated in FIGS. 4A to 4C, which are calculations of the transverse intensity distribution and related radial intensity profiles for a vertically polarized Gaussian beam and a vertically polarized Bessel-Gauss beam for a wavelength of 532 nm. The calculations were performed using the vectorial diffraction theory of Richard and Wolf [B. Richards and E. Wolf, “Electromagnetic Diffraction in Optical Systems. II. Structure of the Image Field in an Aplanatic System”, Proc. R. Soc. A, vol. 253, No. 1274, pp. 358-379 (1959)]. It can be seen from FIG. 4C that, in this example, the FWHM of the central lobe of the Bessel-Gauss beam (203 nm) is about 20% narrower than the FWHM of the corresponding Gaussian beam (240 nm).

However, as also mentioned above, the side lobes and the extended depth of field of Bessel-Gauss and other Bessel-type beams can offset or reduce their benefits in terms of lateral resolution enhancement. As described further below, the present techniques aim to take advantage of the improved lateral resolution achievable by Bessel-Gauss and other Bessel-type beams, while suppressing or at least reducing the generally deleterious effects on image quality caused by their side lobes and extended depth of field.

Referring still to FIG. 1, the beam-conditioning optics 28 is positioned and configured for converting the intermediate Bessel-type beam 44 into an annular beam 46. In the present description, the term “annular beam” refers to a beam whose intensity distribution defines a peripheral ring-shaped region of maximum intensity with no or negligible on-axis intensity.

The lens 32 shown in FIG. 1 is referred to herein as a “Fourier-transform lens” to indicate that it is used to perform a two-dimensional Fourier transform on the intermediate Bessel-type beam 44 in order to generate the annular beam 46: As known in the art, a focusing lens can be used to perform a real-time Fourier transform of an optical signal. It is also known that Bessel and annular beams are closely related through their Fourier transforms, namely that the Fourier transform in polar coordinates of an annular beam is a Bessel beam, and vice versa. Therefore, in embodiments where the intermediate Bessel-type beam 44 is a Bessel-Gauss beam, the Fourier-transform lens 32 can be used to produce the annular beam 46.

It will be understood that the term “Fourier-transform lens” as used herein may refer to both individual lenses and lens systems as well as to other focusing optics. In particular, the Fourier-transform lens 32 may be embodied, for example, by a single lens, an achromat, a doublet, a triplet, an adjustable-focus lens, a plurality of lens, or a combination thereof.

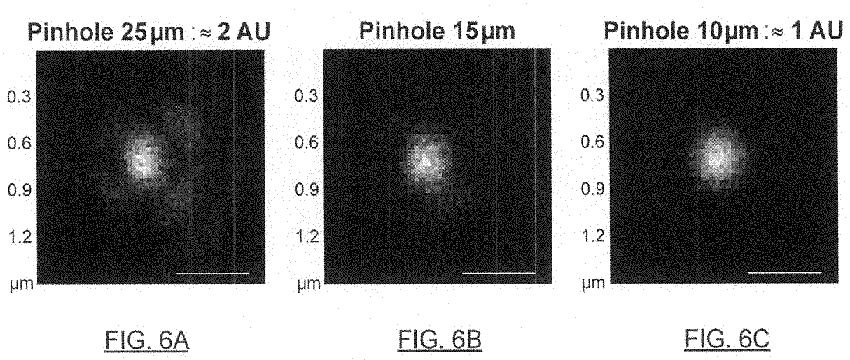

Turning now to FIG. 5, a schematic ray-trace representation of the propagation and transformation of the source optical beam 42 as it travels through the optical microscopy system is depicted. As illustrated in FIG. 5, in some embodiments, the axicon 30 and the Fourier-transform lens 32 (focal length: fₐ) may be disposed relative to each other so as to be separated by a distance d₁ selected such that the back focal plane 88a of the Fourier-transform lens 32 lies within the non-diffracting region 70 of the intermediate Bessel-type beam 44, preferably close to the center 72 thereof. Likewise, it will be understood that the distance d₂ between the Fourier-transform lens 32 and the next optical element of the optical microscopy system 20 (e.g., the objective 34 in FIG. 5 or the entrance of the scanning module 40 in FIG. 1) may, but need not, be optically conjugate with the front focal plane 88b of the Fourier-transform lens 32 (which is located at a distance fₐ in front of the Fourier-transform lens 32).

The Fourier-transform lens 32 in FIG. 5 receives the intermediate Bessel-type beam 44 and performs a Fourier transform thereon to generate an annular beam 46. It will be understood that in order to reduce power losses, the numerical aperture of the Fourier-transform lens 32 is preferably large enough to accept light from the axicon 30 within a range of angles equal at least to 2β. Also, in some embodiments, the Fourier-transform lens 32 may have an adjustable focus. For example, the adjustable-focus lens may be embodied by an electroactive polymer lens, a tunable elastic membrane lens, an adaptive liquid crystal lens, a varifocus zoom lens module, an adjustable zoom telescope module, and the like.

Referring back to the exemplary embodiment of FIG. 1, as the annular beam 46 exits the beam-conditioning optics 28, it is reflected by a light separation element 48 (e.g., a dichroic mirror), relayed through the scanning module 40, described in greater detail below, and collected by the objective 34. In some embodiments, the Fourier-transform lens 32 is disposed so that its front focal plane 88b is optically conjugate with the back-aperture plane 90a of the objective 34. In such a case, the annular beam 46 is imaged on the back-aperture plane 90a of the objective 34. In the present description, two planes are said to be optically conjugate planes if a point on one of the planes is imaged on the other one of the planes, and vice versa. More specifically, in the embodiment of FIG. 1, the Fourier-transform lens 32 may be positioned so that the annular beam 46 is formed at the entrance of the scanning module 40, which corresponds to the plane conjugate of the back-aperture plane 90a of the objective 34. One skilled in the art will understand that this may be accomplished by positioning the Fourier-transform lens 32 so that its front focal plane 88b coincides with the entrance of the scanning module 40.

Referring still to FIG. 1, the optical microscopy system 20 further includes an objective 34 disposed in a path of the annular beam 46. In the present description, the term “objective” generally refers to any lens or focusing optics, or systems thereof, used to form an image of an object. The term is meant to encompass objectives made with refractive, reflective and/or diffractive components.

The objective 34 receives the annular beam 46 and converts it into an excitation Bessel-type beam 50 having a central lobe 80 and at least one side lobe 86. The objective 34 focuses the excitation Bessel-type beam 50 onto a focal plane 60 in or on the volume 22 of the sample 24. Illumination of the volume 22 of the sample 24 by the excitation Bessel-type beam 50 generates a light signal 52 from the volume 22 of the sample 24.

In the exemplary embodiment of FIG. 1, the objective 34 is preferably formed and disposed so as to generate a Bessel-Gauss beam as the excitation Bessel-type beam 50. Therefore, in some embodiments, both the intermediate Bessel-type beam 44 and the excitation Bessel-type beam 50 are Bessel-Gauss beams. One skilled in the art will understand that, similarly to the Fourier-transform lens 32, the objective 34 in the embodiment of FIG. 1 performs an inverse Fourier transform on the annular beam 46 by converting it into the excitation Bessel-type beam 50 (e.g., a Bessel-Gauss beam).

The transverse intensity profile of the excitation Bessel-type beam 50 that is focused on or inside the sample 24 can therefore be the same as the intermediate Bessel-type beam 44, i.e., with a central lobe 80 and at least one side lobe 86. However, because of the magnification generally experienced by the annular beam 46 between the Fourier-transform lens 32 and the objective 34, the excitation Bessel-type beam 50 is generally a scaled-down version of the intermediate Bessel-type beam 44.

Returning to FIG. 5, it is illustrated how the provision of the beam-conditioning optics 28 (including the axicon 30 and the Fourier-transform lens 32) between the optical source 26 and the objective 34 allows the generation of an excitation Bessel-type beam 50 (e.g., a Bessel-Gauss beam) through successive transformations of an input optical beam 42 (e.g., a Gaussian beam).

It will be appreciated that depending on the particular application or use, the lateral resolution and the depth of field of the excitation Bessel-type beam 50 can have different values, which may be set by adjusting one or more of the following non-limiting parameters: (i) the wavelength and the width of the beam 42 generated by the optical source 26; (ii) the refractive index n₂ and the angle α of the axicon 30; (iii) the focal length fₐ of the Fourier-transform lens 32; (iv) the magnification provided by the scanning module 40; and (v) the focal length and the numerical aperture of the objective 34.

In the present techniques, it is generally desirable that both the lateral resolution and the depth of field of the excitation Bessel-type beam 50 be minimized or at least reduced. By way of example, a small lateral resolution and a short depth of field can generally be achieved when the annular beam 46 produced by the Fourier-transforms lens 32 and collected by the objective 34 has a large diameter, yet not large to an extent that it is not fully encompassed inside the collection aperture of the objective 34. In turn, an annular beam 46 with a large diameter can be obtained by increasing the angle α of the axicon 30 and/or by increasing the focal length fₐ of the Fourier-transform lens 32. Meanwhile, a short depth of field can also be achieved when the annular beam 46 has a narrow thickness, which, in turn, can be obtained by reducing the width of the optical beam 42 (e.g., laser beam) generated by the optical source 26 (e.g., laser source).

In the present description, the term “sample light signal” when referring to electromagnetic radiation originating from a region of the sample as a result of being illuminated by the excitation Bessel-type beam is understood to encompass not only fluorescence emission, but also any electromagnetic radiation reflected, scattered or transmitted by the sample or any other type of radiation resulting from the interaction of the excitation Bessel-type beam and the illuminated region of the sample.

In the exemplary embodiment of FIG. 1, the sample light signal 52 is collected by the objective 34 and relayed back by the scanning module 40 along the same path as the annular beam 46. Upon reaching the light separation element 48, the sample light signal 52 is separated from the annular beam 46 and directed to the spatial filter 36 by a focusing lens 92. The light separation element 48 may be embodied by a dichroic mirror or another device or combination of devices able to separate the annular beam 46 from the sample light signal 52 emanating from the illuminated region of the sample 24. The objective 34 and the focusing lens 92 form a telescope, so that the focal plane 60 of the objective 34 located in or on the sample 24 is optically conjugate with the focal plane of the focusing lens 92, which corresponds to the location of the spatial filter 36.

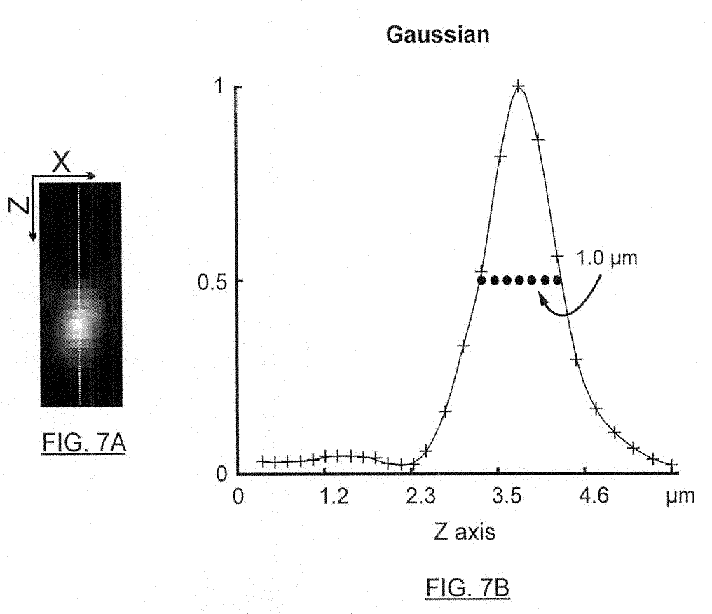

The spatial filter 36 can be embodied by a pinhole, a mask or any other suitable spatial filtering component. The spatial filter 36 can define an aperture 62 (e.g., a slit) whose size (e.g., its surface area) and/or shape may be adjustable. The spatial filter 36 can also include a light-blocking portion 76 surrounding the outer perimeter of the aperture 62. In some implementations, the size (i.e., linear dimensions) of the pinhole may range from about 1 μm to about 1 millimeter (mm), depending on the particular application and microscope configuration. By way of example, the diameter of the pinhole used to obtain the measurements shown in FIGS. 6A, 6B and 6C ranges between 10 μm and 25 μm.

In some embodiments, the optical microscopy system 20 already includes an element that can be used as the spatial filter 36. For example, when the optical microscopy system 20 is a confocal microscope, the spatial filter 36 can be embodied by the pinhole already provided with the system. However, in other embodiments, the optical microscopy system 20 may not a priori include a suitable spatial filtering element. This can be the case, for example, when the optical microscopy system 20 is a two-photon microscope. In this scenario, the spatial filter 36 used in the present technique would be provided as an add-on or a supplementary component to be retrofitted into the system 20.

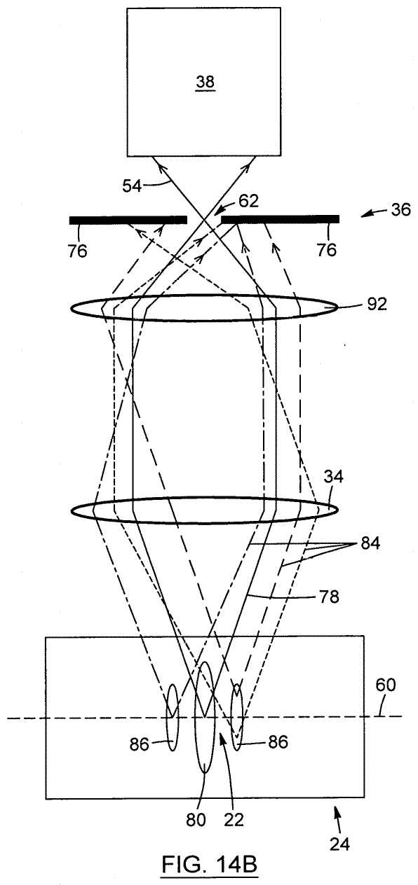

Referring to FIGS. 14A and 14B, the spatial filter 36 is positioned and configured to remove undesired components 82, 84 from the sample light signal 52. As a result, only the component 78 of the sample light signal 52 generated within the focal plane 60 of the objective 34 and by the central lobe 80 of the excitation Bessel-type beam 50 is detected by the detector 38 as a filtered light signal 54. Meanwhile, the remainder 82, 84 of the sample light signal 52 is rejected by the light-blocking portion 76 of the spatial filter 36. As mentioned above, if these undesired components 82, 84 were to reach the detector 38, they would most likely degrade the image contrast, resolution and/or overall quality. The correct position of the spatial filter 36 can be determined by calibration with a control sample, for example 100-nm nanospheres. Referring more specifically to FIG. 14A, the undesired components 82, 84 of the sample light signal 52 include out-of-focus light 82 originating from above (dotted lines) and below (dashed lines) the focal plane 60. As illustrated in FIG. 14A, these out-of-focus components 82 of the sample light signal 52 are blocked by the light-blocking portion 76 of the spatial filter 36 and thus do not reach the optical detector 38. Meanwhile, the component 78 (solid lines) of the sample light signal 52 generated within the focal plane 60 of the objective 34 by the central lobe 80 of the excitation Bessel-type beam 50 passes through the aperture 62 of the spatial filter 36 and reaches the optical detector 38. Referring now to FIG. 14B, the undesired components 82, 84 of the sample light signal 52 also includes light 84 generated by the side lobes 86 of the excitation Bessel-type beam 50 and originating either from above (dotted lines) or below (dashed lines) the focal plane 60 or from the focal plane 60 (dashed-dotted lines). As illustrated in FIG. 14A, these components 84 of the sample light signal 52 generated by the side lobes 86 of the excitation Bessel-type beam 50 are blocked by the light-blocking portion 76 of the spatial filter 36 and thus do not reach the optical detector 38. Meanwhile, and as in FIG. 14A, the component 78 (solid lines) of the sample light signal 52 generated within the focal plane 60 of the objective 34 by the central lobe 80 of the excitation Bessel-type beam 50 passes through the aperture 62 of the spatial filter 36 and reaches the optical detector 38.

Returning to FIG. 1, it is seen that the aperture 62 of the spatial filter 36 is configured (e.g., sized, shaped and positioned) to permit passage therethrough, as the filtered light signal 54, of the component 78 of the sample light signal 52 generated by the central lobe 80 of the excitation Bessel-type beam 50 within the focal plane 60 of the objective 34. Meanwhile, the light-blocking portion 76 of the spatial filter 36 is configured (e.g., sized, shaped and positioned) to reject, from the sample light signal 52, the light 82 originating from outside of the focal plane 60 of the objective 34 and the light 84 generated by the at least one side lobe 86 of the excitation Bessel-type beam 50.

In the present techniques, the use of the spatial filter 36 therefore allows reducing or even eliminating the negative effects of the Bessel side lobes, while also preserving the optical sectioning capabilities found in conventional laser scanning microscopy, which otherwise would be lost as a result of the extended depth of field of Bessel-type beams. For example, when the optical microscopy system 20 is a confocal microscope, such as in the exemplary embodiment of FIG. 1, the optical sectioning capabilities of the confocal microscope are preserved when the confocal pinhole is used as the spatial filter 36.

It will be understood that obtaining a high-resolution image generated only or almost entirely by the central lobe of the excitation Bessel-type beam generally involves an adjustment of the spatial filter to ensure proper rejection of light originating from outside of the focal plane and light generated by the side lobes of the excitation Bessel-type beam. In particular, when the spatial filter 36 is a confocal pinhole, such as in the exemplary embodiment of FIG. 1, a parameter that can be controlled is the size of the pinhole.

By way of example, FIGS. 6A to 6C illustrate the effect of the size of the pinhole on the experimental transverse PSF of a confocal microscope under Bessel-Gauss illumination. The experimental transverse PSFs were measured using 100-nanometer fluorescent nanospheres. FIGS. 6A to 6C illustrate that fluorescent emission light produced by the side lobes of the excitation Bessel-Gauss beam are effectively suppressed when the size of the pinhole is equal to 1 Airy unit, as in FIG. 6C. As known in the art, the Airy unit corresponds to the radius of the first dark ring of the Airy disk, that is, the distance from the center of the major peak to the first minimum. The Airy disk represents the PSF of a point source imaged by a diffraction-limited system including a circular aperture. In general, it has been observed that when the size of the pinhole becomes large compared to the Airy unit, the sectioning capabilities tend to be reduced, giving rise to degradation of the image quality due to out-of-focus light generated by the extended depth of field and/or the side lobes of the excitation Bessel-type beam (see FIGS. 6A and 6B). On the other hand, when the size of the pinhole becomes small compared to the Airy unit, the strength of the measured signal may become too weak.

It will be understood that in the case of Bessel-type beam illumination, the energy of the excitation beam is distributed axially over the extended depth of field as well as radially over the side lobes. As a result, the energy contained in the central lobe is often substantially reduced compared to that under Gaussian illumination. To compensate for this effect, the power of the beam generated by the optical source generally has to be increased to provide an excitation Bessel-type beam having an amplitude comparable to that obtained under Gaussian illumination. This effect also underlines the advantage of being able to tailor the depth of field of the excitation Bessel-type beam according to the requirements and specificities of a particular application or use. In this regard, it has been found that, in some implementations of the present techniques, the increased power requirements necessitated due to Bessel illumination generally do not become so important as to necessitate a laser source more powerful than those used in conventional laser scanning microscopy. In some implementations, it has been found that a laser having a power in the milliwatt range can be enough. For example, in one of these implementations, the power used for Gaussian illumination was in the range of a few microwatts while the power used for Bessel-Gauss illumination was in the range of few tens of microwatts.

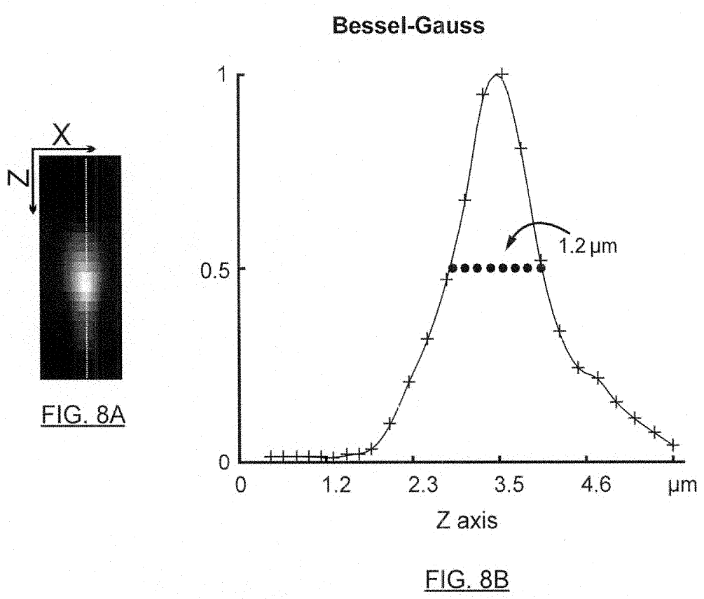

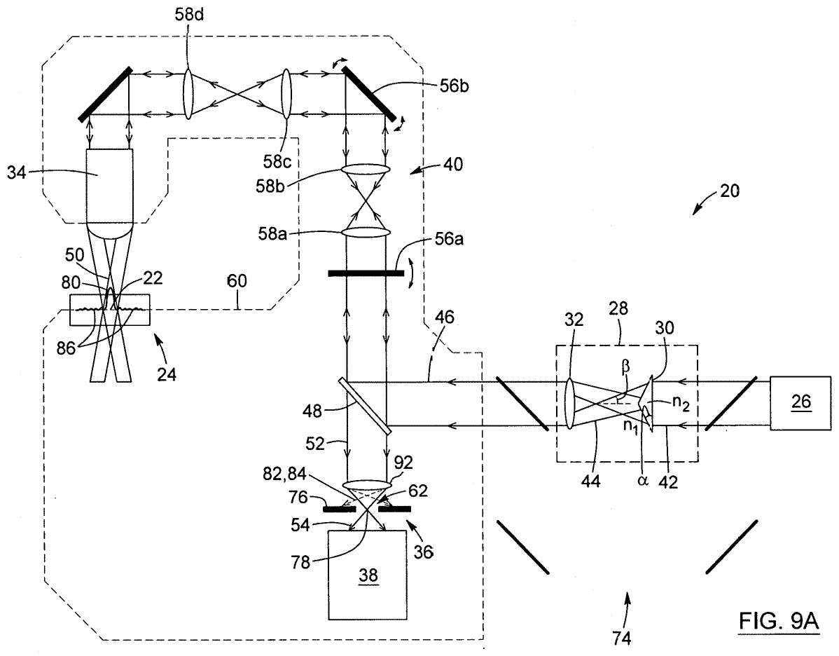

As mentioned above, in some embodiments, it has also been found that using Bessel-Gauss beams rather than Gaussian beams can improve the lateral resolution of a confocal microscope, without significantly compromising the axial resolution. Referring to FIGS. 7A and 7B and FIGS. 8A and 8B, it is seen that the depth of field (i.e., axial resolution along the z-axis), measured in this case by the FWHM of the longitudinal intensity profile along the main peak of the PSF, is only slightly longer under Bessel-Gauss illumination (1.2±0.12 μm; FIGS. 8A and 8B) than under Gaussian illumination (1.0±0.12 μm; FIGS. 7A and 7B). Hence, even if the Bessel-Gauss beam has a longer depth of field, the use of the spatial filter (e.g., confocal pinhole) provides substantially the same axial sectioning capabilities (i.e., approximately 1 μm≈2λ) as with a Gaussian beam.

Returning to FIG. 1, the optical microscopy system 20 also includes an optical detector 38 configured to detect the filtered light signal 54 received from the spatial filter 36. The detector 38 generates from the filtered light signal 54 one of a plurality of pixels of the high-resolution image of the volume 22 of the sample 24. The filtered light signal 54 detected by the detector 38 may be converted into an electrical signal and recorded by a processor (not shown).

As known in the art, the filtered light signal 54 detected by the detector 38 and originating from one diffraction-limited spot or region of the volume 22 of the sample 24 illuminated by the central lobe of the excitation Bessel-type beam 50 generally represents one of a plurality of pixels of the image of the volume 22 of the sample 24. By scanning the excitation Bessel-type beam 50 over the volume 22 of the sample 24, a whole image can be obtained.

In the exemplary embodiment of FIG. 1, the detector 38 is embodied by a photomultiplier tube, although other types of photodetectors can be used in other embodiments such as, for example and without limitation, avalanche photodiodes, PIN detectors and photodiodes, charge-coupled-device (CCD) cameras, complementary metal-oxide-semiconductor (CMOS) cameras or electron multiplying CCD (EMCCD) cameras.

As mentioned above, laser imaging systems and microscopes usually involve a scanning of the laser beam over the sample in order to build an image thereof pixel by pixel, each pixel representing the observation of a small and usually diffraction-limited region of the sample or a portion thereof. Therefore, in some embodiments, the optical microscopy system 20 includes a scanning module 40 (e.g. a scan head) for scanning the excitation Bessel-type beam 50 over the entire volume 22 of the sample 24.

In the embodiment of FIG. 1, the scanning module 40 is configured to relay the annular beam 46 produced by the Fourier-transform lens 32 to the objective 34, and to scan the excitation Bessel-type beam 50 over the sample 24 so as to build the high-resolution image of the volume 22 of the sample 24 from the plurality of pixels thereof.

As mentioned above, in some embodiments, the scanning module 40 is positioned so that its entrance (i.e., first deflecting element 56a) coincides with the front focal plane 88b of the Fourier-transform lens 32 (i.e., at a distance fₐ after the Fourier-transform lens 32) and its exit coincides with the back-aperture plane 90a of the objective 34, respectively. In such embodiments, the front focal plane 88b of the Fourier-transform lens 32 is optically conjugate with the back-aperture plane 90a of the objective 34. This configuration allows for the annular beam 46 generated by the Fourier-transform lens 32 to be imaged on the back-aperture plane 90a of the objective 34, and be subsequently converted by the objective 34 into the excitation Bessel-type beam 50 for illumination of the volume 22 of the sample 24.

The scanning module 40 may include first and second deflecting elements 56a, 56b disposed in the path of the annular beam 46 for changing the angle of incidence of the annular beam 46 on the objective 34 along two orthogonal directions in a plane perpendicular to the optical axis. This causes the excitation Bessel-type beam 50 to scan the volume 22 of the sample 24 in two dimensions. Rotating the deflecting elements 56a, 56b about respective pivot axes enables tilting the annular beam 46 along the back-aperture plane 90a of the objective 34 in two orthogonal directions, thereby allowing a two-dimensional scan of the excitation Bessel-type beam 50 to be performed. The scanning module 40 may also include a piezo-positioner or another suitable device for displacing the objective 34 along its optical axis to change the depth of the focal plane 60 inside the sample 24.

In some embodiments, the scanning module 40 may further include relay lenses 58a, 58b disposed between the first and second deflecting elements 56a, 56b and relay lenses 58c, 58d disposed between the second deflecting element 56b and the objective 34.

In the illustrated embodiment, the deflecting elements 56a, 56b are embodied by scanning mirrors such as, for example, galvanometric mirrors, while the relay lenses 58a, 58b and 58c, 58d are embodied by pairs of achromatic doublets. Of course, other optical components can be used in other embodiments rather than deflecting element and/or relays lenses. For example, in other embodiments, the scanning module can include one or more among a resonance scanner, a piezoelectrical scanner, a rotary polygon scanner, an ultrasonic vibrator deflector, a prism module, an electro-optic deflector, and the like.

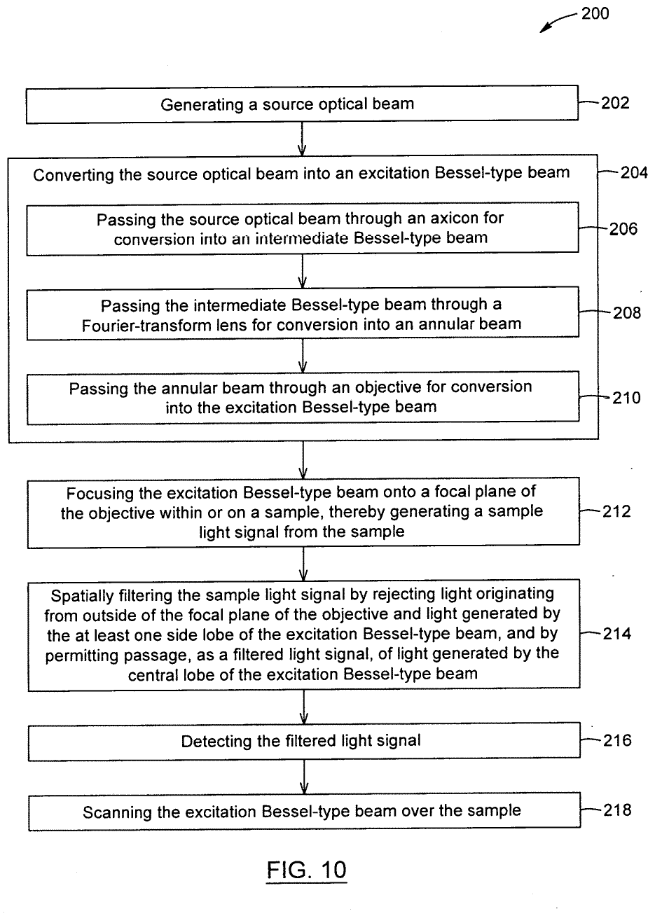

In accordance with another aspect, there is provided a method for improving lateral resolution in optical microscopy. Referring to FIG. 10, there is shown a flow chart of an embodiment of the method 200. The method 200 could, by way of example, be performed with a laser imaging system as described above with reference to the embodiments of FIG. 1 and FIGS. 9A and 9B, or with another laser imaging or optical microscopy system.

The method 200 first includes a step 202 of generating a source optical beam. The source optical beam may have different optical characteristics (e.g., wavelength, frequency, intensity, polarization, and size) depending on the intended application of the method. In particular, the source optical beam may be generated with a frequency lying in any appropriate portion region of the electromagnetic spectrum, including the visible, infrared and ultraviolet frequency ranges. By way of example, in some implementations, the source optical beam lies in a wavelength range extending from 10 nm to 10 μm, for example from 200 nm to 5 μm. The source optical beam may be a pulsed laser beam or a continuous-wave beam. Also, the laser beam may be a laser beam, for example a Gaussian laser beam whose transverse electrical field and intensity distribution are well approximated by Gaussian functions.

The method 200 also includes a step 204 of converting the source optical beam into an excitation Bessel-type beam having a central lobe and at least one side lobe. This converting step is generally performed in three stages, which are described below.

First, the converting step 204 includes a sub-step 206 of passing the source optical beam through an axicon, thereby converting the source optical beam into an intermediate Bessel-type beam. In an embodiment where the source optical beam is a Gaussian beam, the axicon is positioned and configured to convert the Gaussian beam into a Bessel-Gauss beam (see, e.g., FIG. 3). As mentioned above, a Bessel-Gauss beam represents a close approximation to an ideal Bessel beam, which retains the non-diffractive nature of its central lobe.

Second, the converting step 204 also includes a sub-step 208 of passing the intermediate Bessel-type beam through a Fourier-transform lens, thereby converting the intermediate Bessel-type beam into an annular beam. As mentioned above, the Fourier-transform lens performs a two-dimensional Fourier transform on the intermediate Bessel-type beam in order to generate the annular beam. In some implementations, the method 200 can include a step of adjusting a focal length of the Fourier-transform lens so that a back focal plane of the Fourier-transform lens coincides, or substantially coincides, with a center of the intermediate Bessel-type beam produced by the axicon.

Third, the converting step 204 includes a sub-step 210 of passing the annular beam through an objective, thereby converting the annular beam into the excitation Bessel-type beam. One skilled in the art will understand that, while in the conversion of the intermediate Bessel-type beam into an annular beam involved performing the Fourier transform of the intermediate Bessel-type beam, the conversion of the annular beam into the excitation Bessel-type beam generally involves performing an inverse Fourier transform on the annular beam by converting it back into a beam having a Bessel-Gauss profile.

The method 200 next includes a step 212 of focusing the excitation Bessel-type beam onto a focal plane of the objective, the focal plane being located within or on the sample, thereby generating a sample light signal from the sample.

The method 200 also includes a step 214 of spatially filtering the sample light signal. The spatial filtering includes rejecting, from the light signal, not only light originating from outside of the focal plane, but also light generated by the at least one side lobe of the excitation Bessel-type beam, while permitting passage of light generated by the central lobe of the excitation Bessel-type beam as a filtered light signal. The filtered light signal represents the signal of interest for imaging the sample. In some implementations, the step 214 of spatially filtering the sample light signal includes passing the sample light signal through an aperture. In some implementations, the method 200 can include adjusting at least one of the size, the shape and the position of the aperture in accordance with a width and/or a position in space (i.e., after focusing by the objective) of the central lobe of the excitation Bessel-type beam. By way of example, the size of the aperture can be adjusted in a range extending from 1 μm to 1 mm. In some implementations, the position of the aperture can be adjusted prior to each image acquisition. It will be noted that the position of the focal plane of a Bessel-Gauss is generally not the same as that of the corresponding Gaussian beam. In some implementations, the position of the aperture can be adjusted first longitudinally (i.e., along the optical axis) to determine the correct plane, and then transversely to center the excitation Bessel-Gauss beam on the focal plane. In some implementations, a lens provided before the aperture rather than the aperture itself can be adjusted to find the correct focal plane.

The method 200 further includes a step 216 of detecting the filtered signal.

In some implementations, the method 200 can include a step 218 of scanning the excitation Bessel-type beam over the sample.

Experimental demonstrations illustrating the lateral resolution enhancement capabilities provided by some embodiments of the present techniques will now be described. It is noted that these experimental demonstrations are also described in L. Thibon et al., “Resolution enhancement in confocal microscopy using Bessel-Gauss beams”, Optics Express, Vol. 25, No. 3, pp. 2162-2177 (2017), the disclosure of which is incorporated herein by reference in its entirety. The present techniques are not limited to these particular experimental demonstrations.

The experimental demonstrations described below were performed with a laser scanning imaging system configured for confocal microscopy. This system allows for the insertion of beam-conditioning optics including an axicon and a Fourier-transform lens between the laser source and the entrance of the scanning module. These experimental demonstrations aimed to determine the resolution of Bessel-Gauss beams used in confocal microscopy compared to the resolution of Gaussian beams. This determination has been done by observing nanospheres and small structures in biological samples (e.g. microtubules and synaptic markers), which are commonly used structures to test the resolution of a microscope.

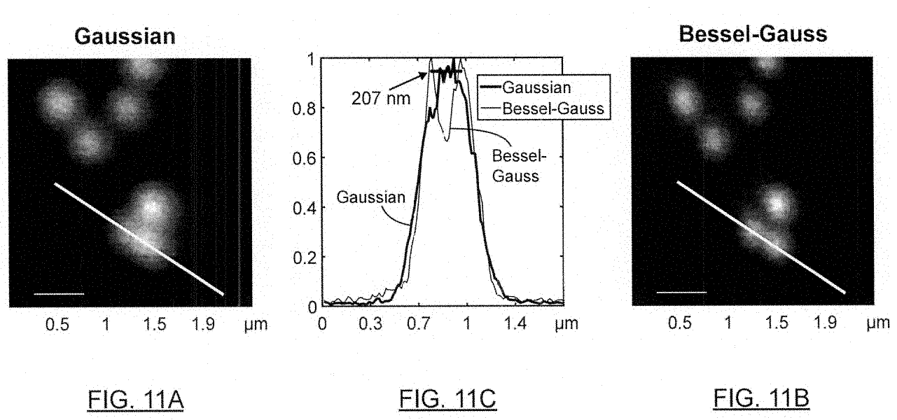

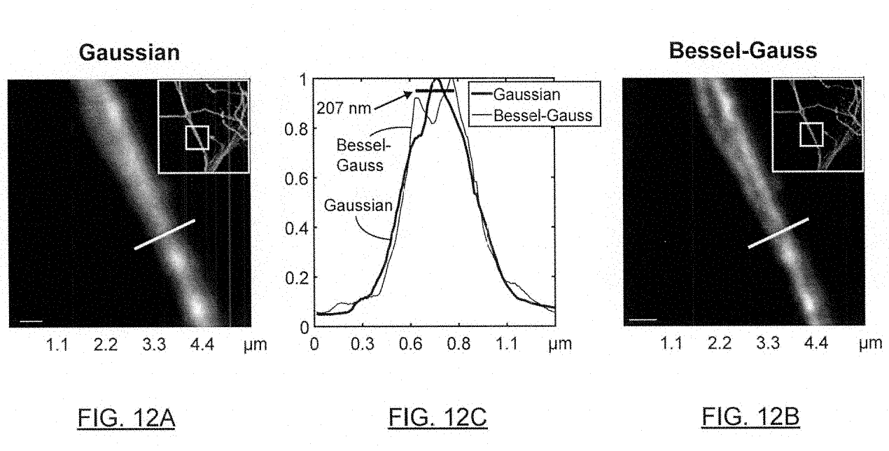

Referring to FIGS. 11A to 11C, resolution measurements on fluorescent nanospheres of 100-nm diameter smeared on a glass coverslip and mounted on a slide using a mounting medium having a refractive index of 1.47. FIGS. 11A to 11C show a resolution improvement obtained with the Bessel-Gauss beam compared with the Gaussian beam. In particular, FIG. 11B shows a resolution of about 207±12 nm (≈0.39λ) with the Bessel-Gauss beam, which is below the theoretical resolution limit of the system with the same optics. The theoretical limit was defined by the Rayleigh criterion: 1.22(λ/2NA)≈270 nm≈0.51λ, which agrees with theoretical computations made with Gaussian beams incident on the objective. The relative improvement in resolution is about 23%.

A better resolution between different fluorescently labelled proteins or proteins tagged by fluorescent antibodies is desirable or required in many aspects of biology, namely to count labels and distinguish structures. To show the resolution improvement made possible by the use of a Bessel-Gauss beam, two types of biological samples were used. First, microtubules with fluorescently labelled antibodies (monoclonal anti α-tubulin antibody) were detected to verify whether microtubule bundles could be distinguished within small cellular compartments. Second, proteins forming clusters (markers of neuronal synaptic junction) were detected to verify if clusters are more easily resolved.

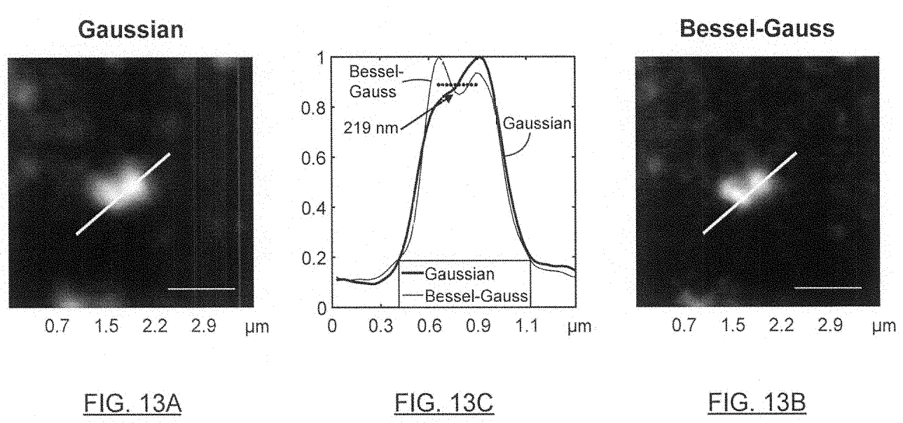

A first experimental demonstration of resolution improvement achieved with fluorescent immunostained microtubule samples is shown in FIGS. 12A to 12C. Because of their small diameter 25 nm), microtubules are typical structures used to illustrate resolution measurements. The profiles shown in FIG. 12C are integrated profiles along a 5-pixel width line. A resolution improvement is observed with the Bessel-Gauss beam as compared with the Gaussian beam. The resolution measured with the Bessel-Gauss beam is about 207±12 nm (≈0.39λ) which is better than the theoretical resolution 270 nm (≈0.51λ) achieved with the Gaussian beam. As in FIGS. 11A to 11C, the relative resolution improvement is about 23%. Comparing FIGS. 12A and 12B, the microtubule bundles can be distinguished when using the Bessel-Gauss beam but not when using the Gaussian beam.

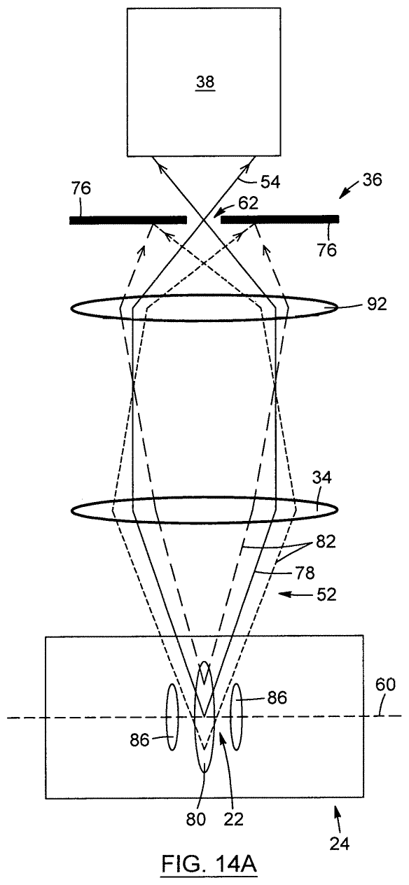

A second experimental demonstration of resolution improvement achieved with a neuronal synaptic staining is shown in FIGS. 13A to 13C. Detection of the gephyrin protein by immunofluorescence was performed. The gephyrin protein is a marker of inhibitory synaptic junction in neurons and is thus present in the form of clusters at the cell membrane. Improved resolution of gephyrin clusters with areas of dense synaptic contacts was demonstrated, such that more inhibitory postsynaptic sites can be resolved. FIGS. 13A to 13C show that two adjacent synaptic gephyrin-positive sites that were not resolved with a Gaussian beam (FIG. 13A) become distinguishable with a Bessel-Gauss beam (FIG. 13B). FIG. 13C indicates a resolution of ≈219±12 nm≈0.41λ with the Bessel-Gauss beam. The relative resolution improvement compared to the theoretical resolution of the Gaussian beam (of ≈270 nm) is about 20%

Some implementations of the present techniques could also be applied to implement the method described in commonly assigned U.S. Pat. Appl. Pub. No. 2014/0321772 to Piché et al., the disclosure of which is incorporated herein by reference in its entirety. Piché et al. describes a method and a laser imaging system for obtaining a high-resolution image of a volume of a sample using laser imaging. The method includes, inter alia, the steps of (i) probing the volume of the sample with a first excitation beam having an intensity profile of maximum intensity at a center thereof, thereby obtaining a positive image of the volume; (ii) probing the volume of the sample with a second excitation beam having an intensity profile of minimum intensity at a center thereof and defining a peripheral region of maximum intensity around the center, thereby obtaining a negative image of the volume; and (iii) subtracting the negative image from the positive image, thereby obtaining the high-resolution image of the volume of the sample. In some embodiments, the first excitation beam can be a Gaussian TEM₀₀ beam and the second excitation beam can be an azimuthally polarized TE₀₁ beam.

Using the techniques described herein, it is possible to obtain the positive image with a vertically polarized Bessel-Gauss beam instead of a Gaussian TEM₀₀ beam and to obtain the negative image with an azimuthally polarized Bessel-Gauss beam of order 1 instead of an azimuthally polarized TE₀₁ beam. The positive and negative images can be subtracted one from the other to obtain an image having a higher resolution. Since the central spot of the Bessel-Gauss beam of order 0 is smaller than that of the Gaussian TEM₀₀ beam and the spot and the central annulus of the azimuthally polarized Bessel-Gauss beam of order 1 is also smaller than those of the azimuthally polarized TE₀₁ beam, some implementations of the present techniques can further improve the method disclosed in Piché et al.

Of course, numerous modifications could be made to the embodiments described above without departing from the scope of the appended claims.

1. A method for improving lateral resolution in optical microscopy, the method comprising:
(a) generating a source optical beam;
(b) converting the source optical beam into an excitation Bessel-type beam having a central lobe and at least one side lobe, the converting comprising:
(i) passing the source optical beam through an axicon, thereby converting the source optical beam into an intermediate Bessel-type beam;
(ii) passing the intermediate Bessel-type beam through a Fourier-transform lens, thereby converting the intermediate Bessel-type beam into an annular beam; and
(iii) passing the annular beam through an objective, thereby converting the annular beam into the excitation Bessel-type beam;
(c) focusing the excitation Bessel-type beam onto a focal plane of the objective within or on a sample, thereby generating a sample light signal from the sample;
(d) spatially filtering the sample light signal, the spatial filtering comprising rejecting, from the sample light signal, light originating from outside of the focal plane of the objective and light generated by the at least one side lobe of the excitation Bessel-type beam, and permitting passage, as a filtered light signal, of light generated by the central lobe of the excitation Bessel-type beam; and
(e) detecting the filtered light signal.

2. The method of claim 1, wherein step (a) comprises generating a laser beam as the source optical beam.

3. The method of claim 1, wherein step (a) comprises generating a Gaussian beam as the source optical beam, sub-step (i) of step (b) comprises generating a Bessel-Gauss beam as the intermediate Bessel-type beam, and sub-step (iii) of step (b) comprises generating a Bessel-Gauss beam as the excitation Bessel-type beam.

4. The method of claim 1, wherein step (a) comprises generating the source optical beam in a wavelength range extending from 200 nanometers to 5 micrometers.

5. The method of claim 1, further comprising a step of adjusting a focal length of the Fourier-transform lens so that a back focal plane of the Fourier-transform lens coincides with a center of the intermediate Bessel-type beam produced by the axicon.

6. The method of claim 1, wherein step (d) comprises passing the sample light signal through an aperture.

7. The method of claim 6, wherein step (d) further comprises adjusting at least one of a size, a shape and a position of the aperture in accordance with a width and a position of the central lobe of the excitation Bessel-type beam.

8. The method of claim 7, wherein adjusting at least one of the size, the shape and the position of the aperture comprises adjusting a linear dimension of the aperture in a range from 1 micrometer to 1 millimeter.

9. The method of claim 1, further comprising a step of scanning the excitation Bessel-type beam over the sample.

10. An optical microscopy system comprising:
an optical source configured to generate a source optical beam;
beam-conditioning optics disposed in a path of the source optical beam, the beam-conditioning optics comprising:
an axicon positioned and configured to convert the source optical beam into an intermediate Bessel-type beam; and
a Fourier-transform lens positioned and configured to convert the intermediate Bessel-type beam into an annular beam;
an objective disposed in a path of the annular beam for converting the annular beam into an excitation Bessel-type beam having a central lobe and at least one side lobe, the objective focusing the excitation Bessel-type beam onto a focal plane of the objective within or on a sample, thereby generating a sample light signal from the sample;
a spatial filter disposed in a path of the sample light signal, the spatial filter being configured to reject, from the sample light signal, light originating from outside of the focal plane of the objective and light generated by the at least one side lobe of the excitation Bessel-type beam, and permitting passage, as a filtered light signal, of light generated by the central lobe of the excitation Bessel-type beam; and
a detector configured to detect the filtered light signal.

11. The optical microscopy system of claim 10, wherein the optical source is a laser source configured to generate a laser beam as the source optical beam.

12. The optical microscopy system of claim 11, wherein the system is configured for one of confocal laser scanning microscopy and two-photon laser scanning microscopy.

13. The optical microscopy system of claim 10, wherein the optical source is configured to generate a Gaussian beam as the source optical beam, the axicon is positioned and configured to generate a Bessel-Gauss beam as the intermediate Bessel-type beam, and the objective is positioned and configured to generate a Bessel-Gauss beam as the excitation Bessel-type beam.

14. The optical microscopy system of claim 10, further comprising a switching module disposed between the optical source and the beam-conditioning optics, the switching module being configured for operation between a first operating mode, wherein the switching module directs the source optical beam onto the beam-conditioning optics, and a second operating mode, wherein the switching module directs the source optical beam along a path that bypasses the beam-conditioning optics.

15. The optical microscopy system of claim 10, wherein the optical source is configured to generate the source optical beam in a wavelength range extending from 200 nanometers to 5 micrometers.

16. The optical microscopy system of claim 10, wherein the axicon is a refractive axicon.

17. The optical microscopy system of claim 16, wherein the axicon has an axicon angle ranging from 1° to 5°.

18. The optical microscopy system of claim 10, wherein the Fourier-transform lens has an adjustable focal length.

19. The optical microscopy system of claim 10, further comprising a scanning module configured to relay the annular beam generated by the Fourier-transform lens to the objective and to scan the excitation Bessel-type beam over the sample.

20. The optical microscopy system of claim 10, wherein the axicon and the Fourier-transform lens are separated from each other by a distance such that a back focal plane of the Fourier-transform lens coincides with a center of the intermediate Bessel-type beam produced by the axicon.

21. The optical microscopy system of claim 10, wherein the Fourier-transform lens has a front focal plane and the objective has a back-aperture plane, the front focal plane of the Fourier-transform lens being optically conjugate with the back-aperture plane of the objective.

22. The optical microscopy system of claim 10, wherein the spatial filter comprises a light-blocking portion surrounding an aperture, the light-blocking portion being configured to reject the light originating from outside of the focal plane and the light generated by the at least one side lobe of the excitation Bessel-type beam, and the aperture being configured to permit passage therethrough of the light generated by the central lobe of the excitation Bessel-type beam.

23. The optical microscopy system of claim 22, wherein the aperture has a size ranging from 1 micrometer to 1 millimeter.

24. The optical microscopy system of claim 22 or 23, wherein the aperture has at least one of an adjustable size, an adjustable shape, and an adjustable position.

25. The optical microscopy system of claim 22, wherein the aperture is circular.
